(19) United States
(12) Patent Application Publication
(10) Pub. No.: US 2022/0080456 A1
(43) Pub. Date: Mar. 17, 2022

(54) PAINT ROLLER COVER FOR MULTICOLOR PAINT, METHOD OF UNIFORMLY APPLYING MULTICOLOR PAINT AND METHOD OF QUANTIFYING UNIFORMITY OF PAINT APPLICATION

(71) Applicants: DOW GLOBAL TECHNOLOGIES LLC, Midland, MI (US); ROHM AND HAAS COMPANY, Collegeville, PA (US)

(72) Inventors: Ruijun ZHAO, Shanghai (CN); Bin CHEN, Shanghai (CN); Hui LIU, Shanghai (CN); Ling LI, Henan (CN); Ellen C. KEENE, Midland, MI (US); Daria MONAENKOVA, Midland, MI (US)

(21) Appl. No.: 17/419,344

(22) PCT Filed: Jan. 31, 2019
(86) PCT No.: PCT/CN2019/074103

§ 371 Date: Jun. 29, 2021

(51) Int. Cl. B05D 5/06; B05C 17/02; B05C 9/06; B05D 1/28

(52) U.S. Cl. CPC B05D 5/065; B05D 1/28; B05C 9/06; B05C 17/0207

(57) ABSTRACT

A paint roller cover for applying multi-color paint is described. The paint roller includes a foam having a surface groove, the foam has an average cell size of 0.3 to 5 mm. The groove have a depth of 1 to 15 millimeters. A method of characterizing the uniformity of paint applied to a surface is also described. Further, a method of uniformly applying multicolor paint is described.

### TECHNICAL FIELD

This application relates to a paint roller cover and a method of uniformly applying paint.

### BACKGROUND

Multicolor paint systems have attracted attention because of the decorative effects possible. As compared to real stone materials, multicolor paint systems can be lighter weight, lower cost, and environmentally friendly. These multi-color paints can be formed by combining two or more single color paints that are stable when added to another paint liquid (e.g. another color paint or a non-colored paint base). Thus, there will be discrete domains of each paint color in the base paint liquid. However, the application of multicolor paint systems is difficult and costly.

Conventionally, multicolor paint is applied using special spray gun. Requirement of special equipment, such as a special spray gun, restricts mass-adoption of multicolor paint.

When applying paints by a roller, a painter often moves the roller back and forth in overlapping strokes on the substrate (e.g. wall). When multicolor paint is applied by a traditional paint roller, such stroking can impair the quality of the paint coating for one or more of the following reasons: too many spots of color aggregate in regions on the substrate, the size of spots becomes too small as domains of the different colors are reduced in size during application, and/or one color may become intermixed with another.

### SUMMARY

Disclosed herein is an application system for multi-color paints which avoids the necessity of using spray equipment. This system enables more use of multi-color paints in do-it-yourself applications as well as professional painter situations. In addition, disclosed herein is a method for characterizing the quality of an application of paint and particularly multi-color paint.

Thus, in an embodiment, there is provided a paint roller cover comprising a foam having (i) a surface extending between a first edge and a second edge and a groove on the surface wherein the groove is characterized in that at least a portion of the groove is positioned at an angle relative to an edge of the foam of and by a groove depth of 1 to 15 millimeters, and (ii) an average cell size in the range of about 0.03 to about 0.5 cm.

The above roller cover is particularly suitable for applying a multicolor paint to a substrate. Thus, in another embodiment, there is provided a method of uniformly applying a multicolor paint which comprises two or more paints of different colors in discrete domains from each wherein the domains have an average domain size, comprising applying the multicolor paint to the paint roller cover mentioned-above, wherein the average cell size of the polyurethane foam is within 25% of the average domain size in the multicolor paint, applying pressure to the paint roller cover to a surface to be painted.

In another embodiment, there is provided a method of characterizing the uniformity of a paint applied to a surface, comprising digitizing an image of a painted surface, measuring spot counts in a y direction and an x direction of the digitized image, calculating the variance of spot counts in the x and y direction, and determining if the variance of spots counts is greater or less than a target value. By spot counts is meant the number of spots over a set distance in the x or y direction. Each spot is a contiguous region of one paint color in the linear direction of measurement (e.g. the x or y direction).

The above-mentioned and other embodiments are described in detail below.

### BRIEF DESCRIPTION OF THE DRAWINGS

FIG. 1 shows a painted surface using a conventional roller.

FIG. 2 shows a painted surface using a roller described here.

FIGS. 3A-C shows images of a painted surface (center) and histograms of the images of the y- and x-coordinates for a non-uniform sample. FIG. 3A corresponds to the image of Comparative Example 1. FIG. 3B corresponds to the image of Comparative Example 2. FIG. 3C corresponds to the image of Comparative Example 3.

FIGS. 4A-C shows images of a painted surface (center) and histograms of the images of the y- and x-coordinates for a uniform sample. FIG. 4A corresponds to the image of Example 1. FIG. 4B corresponds to the image of Example 2. FIG. 4C corresponds to the image of Example 3.

FIG. 5 shows a milling model for a paint roller cover with a helix structure.

FIG. 6 shows a comparison of paint coverage for a roller with no helix structure (left) and having a helix structure (right). The roller was 25 pores per inch, 15 millimeters thick in each case.

FIG. 7 shows images of painted panels prepared using a comparative roller (A, B, C) and a roller described herein (D, E, F).

FIG. 8 shows hardness test results for various foams.

FIG. 9 shows images of foams with various specifications.

FIG. 10 shows a schematic diagram explaining the histogram method for image analysis.

### DETAILED DESCRIPTION

As used herein, the term “PPI” refers to pores per inch.

The inventors hereof have surprisingly found paint roller covers having a particular configuration can provide painted surfaces with more uniform paint coverage. A method for evaluating the uniformity of a painted surface was also discovered.

In an embodiment, there is provided a paint roller cover. The paint roller cover comprises: a foam having (i) a surface extending between a first edge and a second edge and a groove on the surface wherein the groove is characterized in that at least a portion of the groove is positioned at an angle relative to an edge of the foam of and by a groove depth of 1 to 15 millimeters, and (ii) an average cell size in the range of about 0.03 to about 0.5 cm.

The foam is a material that has some compliance for rolling over surfaces and sufficient durability to withstand application of paint and pressure on substrate to be painted and according to certain embodiments cleaning. The roller cover is made of a material that is preferably solvent resistant. The paint roller cover can be made from a synthetic foam, for example, a polyurethane foam. The polyurethane foam can be a polyester polyurethane, polyolefin polyurethane, a polyimide polyurethane, or polyether polyurethane. In an embodiment, the roller cover is made from a polyurethane foam. In an embodiment, the roller cover is made from an open cell foam such as a reticulated polymer foam, for example a reticulated polyurethane foam or an explosive reticulated polyurethane foam.

In an embodiment, the paint roller cover is made from foam (e.g. polyurethane foam) having a cell frequency is at least about 5, 10 or 20 and no more than about 70, 60, 50, 40 or 30 pores (or cells) per inch or about 2, 4, or 8 to about 30, 25, 20, 15, or 12 cells per centimeter. Very small cells can disrupt the paint domains and very large cells may not adequately separate the domains resulting in more paint intermixing. Cell frequency can be determined by examining the foam and counting cells in a given direction. Average cell size can be determined by taking the inverse of cell frequency. According to certain embodiments, the average cell size is according to certain embodiments at least about 0.03, 0.04, 0.05, 0.07, or 0.08 cm and no more than about 0.5, 0.4, 0.3, 0.25, 0.2, or 0.15 cm.

In an embodiment, the paint roller cover is made from a foam having a thickness of at least 5 or 10 millimeters. According to certain embodiments the thickness of the paint roller cover is no more than 30 or 25 or 20 millimeters. The thickness should generally be greater than the average cell size.

In an embodiment, the paint roller cover is made from foam having hardness of at least 20, 25 or 30 and no more than 60 or 55 or 50 degrees as measured as described herein.

The cells or pores of the foam are open to the surface to enable the paint to penetrate and be efficiently picked up by the roller. The cell size of the polyurethane foam can be selected relative to the size of domains of different colors in the multicolor paint for providing more uniform paint coverage. In an embodiment, the average cell size of the foam is within 25% of the average domain size in a multicolor paint. This allows the color domains to be picked up by the paint roller cover when the paint is loaded onto the paint roller cover and then released when the loaded paint roller cover is applied to a surface.

In an embodiment, the paint roller cover is in the form of a cylinder having two edges and a surface extending between the edges. In an embodiment the pain roller cover has an inner cavity for mounting on a support arm. The inner cavity may be defined by an inner surface of the foam or by a core material to which carries the foam or to which the foam is attached. In an embodiment, the paint roller cover comprises a cylindrical core (with or without a cavity). Such a core material or cylindrical core can be any material such as paper, cardboard, or plastic. The paint roller cover can be of a conventional diameter and length to fit standard paint applicator support arms, such as those used for household applications. The paint roller cover can also be of a specialized diameter and length for commercial applications, for example. In an embodiment, the paint roller cover has an outer diameter of at least 50 or 60 millimeters. In an embodiment the outer diameter can be up to 100, 90, 80, 70 or 60 millimeters.

The paint roller cover disclosed herein has one or more grooves on the surface. One or more of the grooves is at an angle relative to the edges of the paint roller cover such that at least a portion of the groove(s) is neither parallel to nor perpendicular to the edges of the roller. For example, the groove(s) may be oriented at an angle of at least 1, 2, 5, 10, 20, 30 degrees and no more than 89, 88, 85, 80, 70, 60 relative to an edge of the foam. According to certain embodiments the groove has a depth of at least 1, 3, or 5 millimeters. The groove depth should be less than the total thickness of the roller cover. According to certain embodiments the groove depth is no more than 15 or 10 or 8 millimeters. The groove width according to certain embodiments is at least 1, 1.5 or 2 millimeters. The groove width according to certain embodiments is no more than 10, 8, 5, or 4 mm millimeters.

The groove may be in a regular or irregular pattern over the surface of the paint roller cover. Examples of groove patterns include helix and diamond shape grooves. For example the helix may run around the roller at a pitch (i.e. distance for one complete turn of the helix around the axis of the roller) of at least 5 or 10 or 15 or 20 millimeters and no more than 50 or 40 or 30 millimeters. The helix may be regular or may vary within the pitch ranges over the surface of the paint roller cover. A diamond shape may have dimensions of the sides of least 5 or 10 or 15 or 20 millimeters and no more than 50 or 40 or 30 millimeters and may be interconnected or separated. In an embodiment, the helix groove is equidistant through the width of the roller cover. In an embodiment, the helix groove is irregular through the width of the roller cover.

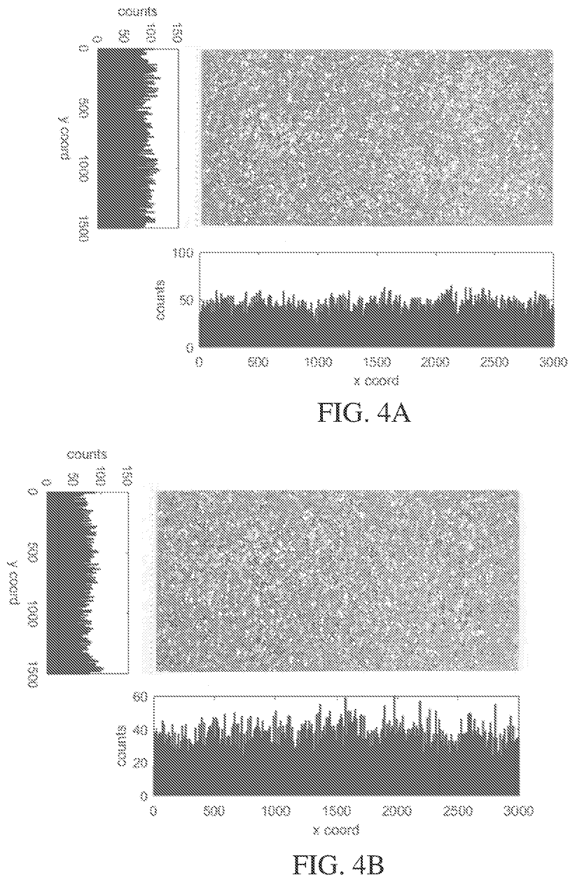

In an embodiment, the paint roller cover has a helix groove formed therein. In an embodiment, the helix groove has a helix thread pitch of 5 to 40 millimeters, preferably 10 to 30 millimeters; and a helix groove depth of 1 to 15 millimeters, preferably 3 to 10 millimeters, preferably 5 to 8 millimeters. The helix groove can be formed by a number of methods, including machining, carving, molding, milling, or cutting. In an embodiment, the helix groove is equidistant through the width of the roller cover. In another embodiment, the helix groove is irregular through the width of the roller cover. FIG. 5 shows one embodiment of a helix groove in a paint roller cover.

The roller as disclosed herein may be made by any known method for making paint cover rollers. For example, a foam having desired pore size, hardness, thickness and other properties, may be milled, machined, carved, or molded to impart the desired groove pattern. The foam may be cut to the desired size and formed into a roll structure. The foam may be adhered to a core material, if used, using an adhesive.

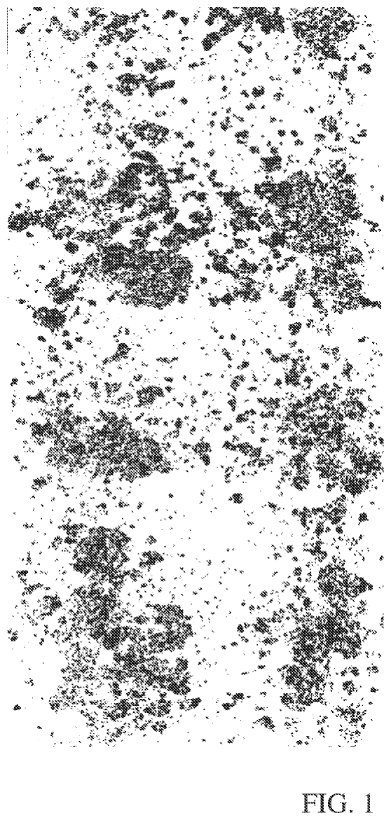

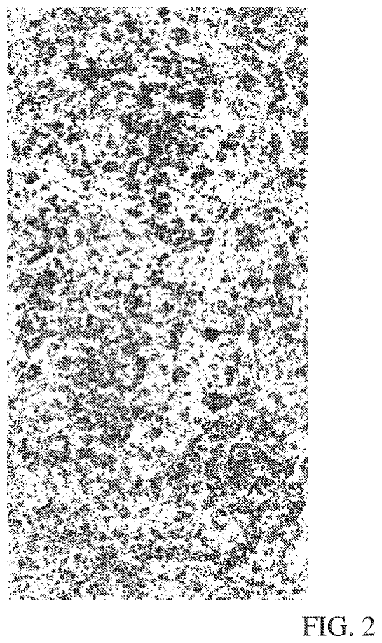

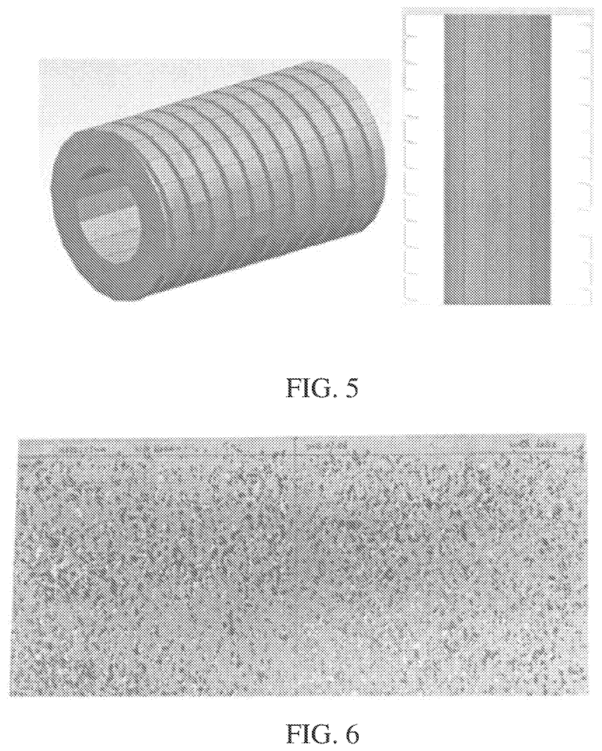

FIG. 1 shows a surface painted with a conventional roller. The dark areas are portions of the surface having paint coverage, the white areas do not have paint coverage. FIG. 2 shows a surface painted with the same paint as in FIG. 2, but with a roller cover as described here. It can be seen that a surface painted using a roller cover as provided gives more uniform paint coverage. Additional examples are provided in FIG. 7, where surfaces painted with a multicolor paint using comparative roller which do not have grooves (FIGS. 7A-C) are compared with surfaces painted with a roller having helical grooves as described herein (FIGS. 7D-F). As can be seen, the surfaces painted with the conventional roller shows areas of uneven paint coverage, while the surfaces painted with the roller as described here shows much more uniform paint coverage. Although the differences in coverage can be qualitatively seen, a quantitative method to distinguish even and uneven coverage was not available until the unexpected discovery of the inventors hereof.

Thus, according to one embodiment disclosed herein is a method of characterizing the uniformity of a paint applied to a surface, comprising digitizing an image of a painted surface, measuring spot counts in a y direction and an x direction of the digitized image, calculating the variance of spot counts in the x and y direction, and determining if the variance of spots counts is greater or less than a target value. By spot counts is meant the number of spots over a set distance. Each spot is a contiguous region of one paint color in the linear direction of measurement (e.g. the x or y direction).

According to one embodiment this method can use a histogram-based analysis to characterize the uniformity of the paint application. A binary image can made such that pixels will be black or white. If an image is uniform at a given size scale, every area selected at that size scale will have essentially the same area fraction of white and black (or light and dark) pixels, and the same average intensity. If the image is non-uniform at a given size scale, an area selected at that size scale can have substantially more or less light or dark pixels, and have different average intensities. The standard deviation of the area fraction for many areas will be larger in this case than for a more uniform image.

For example, images of painted surfaces can be analyzed by using ImageJ software (version 1.51p, written by Wayne Rasband and available as freeware from the US National Institute of Health at http://rsb.info.nih.gov/ij/). The image analysis can be used to determine the uniformity of spot distribution along vertical (y) and horizontal (x) directions of the image. To access the spot count information the images can first be binarized. Further x and y coordinates of particle centers (centroids) on the image can be acquired through image analysis. The number of particles of all colors with centers falling within each strip (zᵢ) was calculated and plotted in a form of a histogram. The histograms reflect the distribution of the particles (i.e. spots) along specific direction of the image. The histogram might also be thought of as a variation in linear density of surface coverage when image is collapsed to a single dimension. Histograms plotted for x and y directions of the image can be used to calculate standard deviation (1) and coefficient of variation (2) of spots count in these two directions. Coefficient of variation is widely used as a measure of repeatability in the array of values. In this case, coefficient of variation of spot density is related to the coverage uniformity. Since spot agglomerations are signified by the presence of peaks on the histogram, non-uniform coverage can result in higher standard deviations and higher values of coefficient of variation.

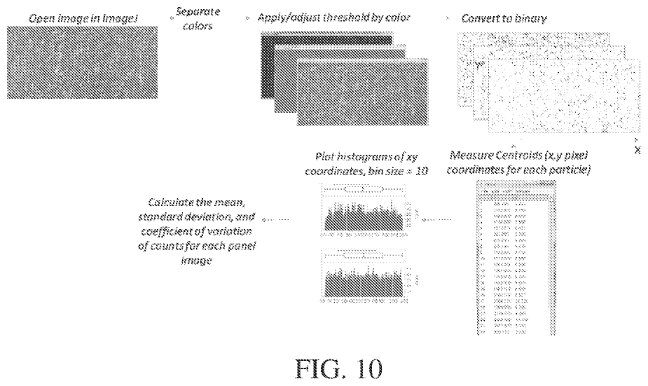

Equation 1 and 2 are standard deviation (std) and coefficient of variation (CV):

$$\begin{matrix}\begin{matrix}s t d ( z ) = \sqrt{\frac{{\sum }_{i = 1}^{N} {( {z}_{i} - \overline{z} )}^{2}}{N - 1}} & \end{matrix} & ( 1 ) \\ CV = \frac{std ( z )}{\overline{Z}} & ( 2 )\end{matrix}$$

where zᵢ is a number of particles falling within i strip, z̅ is a mean number of particle per strip, N is a number of strips in corresponding direction. FIG. 10 describes the histogram method.

In an embodiment, the paint roller cover is made from adjusted foam where the cell size is selected in connection with the domain size of of different color paints in a multicolor paint for providing more uniform paint coverage. In an embodiment, the cell size of the foam is within 25% of the average particle size in a multicolor paint. This allows the particles to be picked up by the paint roller cover when the paint is loaded onto the paint roller cover and then released when the loaded paint roller cover is applied to a surface. Thus, according to an embodiment, disclosed herein is a method of uniformly applying multicolor paint. The method comprises applying multicolor paint comprising domains of different color paint to the paint roller cover described-above, wherein the cell size of the foam is within 25% of the average domain size in a multicolor paint, and rolling the paint roller cover on a surface to be painted. According to certain embodiments, using the method of quantitatively assessing uniformity of paint as disclosed herein such a painted surface shows in a histogram a variance of an average intensity of spots in a painted sample in the x or y direction is smaller than 0.25 or the sum of variances in the x and y direction is less than 0.45.

The methods and rollers described herein are further illustrated by the following non-limiting examples.

### Examples

Three commercial multicolor paints with different sizes of color domains were used, designated 1, 2, and 3. The Krebs units (KU) of each paint was around 75-85. These paints were applied to cement panels using three different paint rollers of reticulated polyurethane foam with helix structures (Examples 1, 2, and 3) and three commercial paint rollers (Comparative Examples 1, 2, and 3). Table 1 presents the characteristics of the rollers used.

TABLE 1

| | | | Helix structure | | |
|---|---|---|---|---|---|
| | Cell | | Thread | Groove | Groove |
| | frequency | Thickness | pitch | depth | width |
| Roller ID | (PPI) | (mm) | (mm) | (mm) | (mm) |
| Example 1 | 25 | 15 | 15 | 5 | 2 |
| Example 2 | 20 | 15 | 15 | 5 | 2 |
| Example 3 | 15 | 15 | 15 | 5 | 2 |
| Comparative | 25 | 15 | N/A | N/A | N/A |
| Example 1 | | | | | |
| Comparative | 20 | 15 | N/A | N/A | N/A |
| Example 2 | | | | | |
| Comparative | 15 | 15 | N/A | N/A | N/A |
| Example 3 | | | | | |

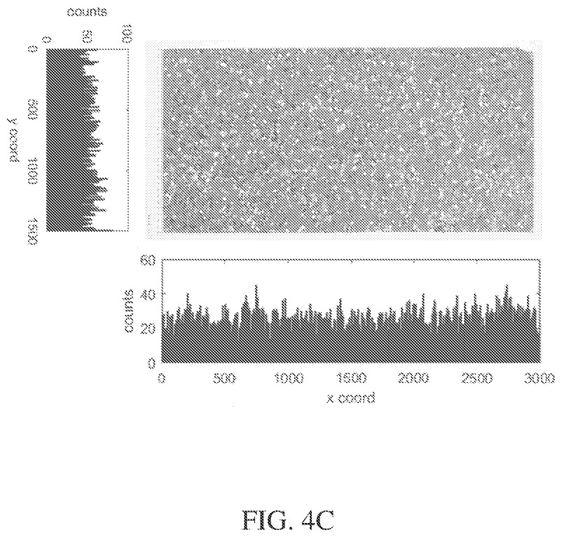

For paint 1, for example, a painted panel using the Comparative Example roller having no helix structure, showed good paint spreadability without breaking the multicolor particles (see, FIG. 6—left). However, using the same paint, a painted panel using the Example 1 roller, where the paint roller had a helix structure, resulted in a much more uniform particle area distribution, and also provided better coverage (see, FIG. 6—right).

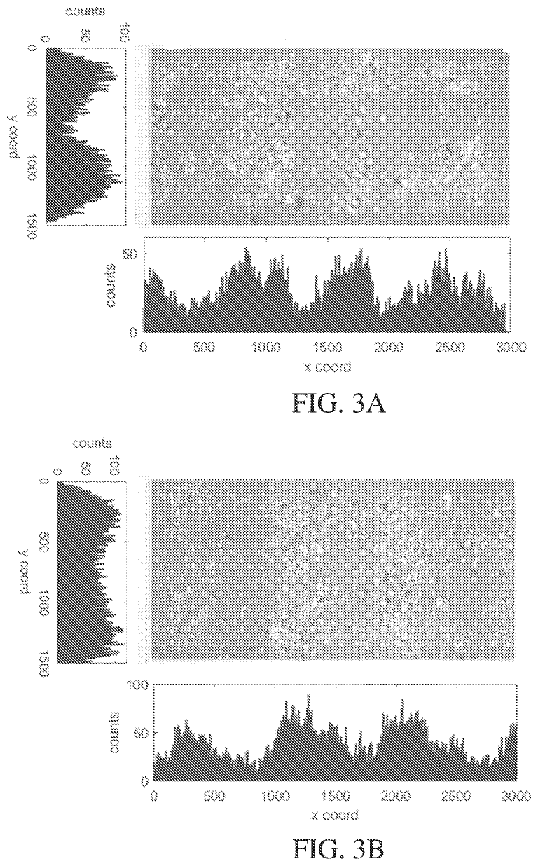

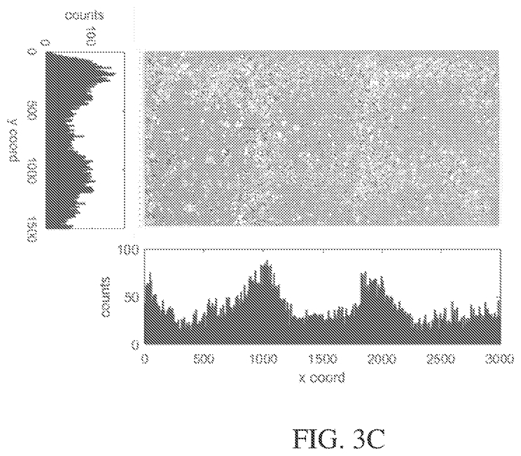

Images were analyzed by using ImageJ software (version 1.51p, written by Wayne Rasband and available as freeware from the US National Institute of Health at http://rsb.info.nih.gov/ij/). The image analysis can be used to determine the uniformity of spot distribution along vertical (y) and horizontal (x) directions of the image. To access the spot count information the images were first binarized such that they have only black and white pixels. To validate the method, binary black and white images were obtained for black, white and yellow colors of the spots separately. However, the method can be used to analyze any color combination. Further x and y coordinates of particle centers (centroids) on the image were acquired through image analysis. Then each image was binned into 10-pixel wide strips in horizontal and in vertical directions. The number of particles of all colors with centers falling within each strip (zᵢ) was calculated and plotted in a form of the histogram. The histograms reflect the distribution of the particles along specific direction of the image. The histogram might also be thought of as a variation in linear density of surface coverage when image is collapsed to a single dimension. Histograms were plotted in both x and y directions of particular image (FIGS. 3 and 4). Histograms plotted for x and y directions of the image were used to calculate standard deviation (1) and coefficient of variation (2) of spots count in these two directions. Coefficient of variation is widely used as a measure of repeatability in the array of values. In this case, coefficient of variation of spot density is related to the coverage uniformity. Since spot agglomerations are signified by the presence of peaks on the histogram, non-uniform coverage can result in higher standard deviations and higher values of coefficient of variation.

Table 2 summarizes the results obtained from image analysis. Using the Comparative roller results in higher standard deviations and higher values of coefficient of variation in spot count, in both x and y directions, across the image. More uniform coverage is achieved when samples are prepared using a roller described here (designated as “Example”) in comparison to a comparative roller (designated as “Comparative”). In other words, the paint roller as described here provides lower standard deviation and low variation in spot counts in both x and y directions. Thus, the paint rollers described here are superior to traditional paint rollers.

TABLE 2

| | Count | St. | | Avg CV ± | Count | St. | | Avg CV ± |
|---|---|---|---|---|---|---|---|---|
| | Avg | Dev. | CV | St. Dev. | Avg | Dev. | CV | St. Dev. |
| Image Name | (x) | (x) | (x) | (x) | (y) | (y) | (y) | (y) |
| A (Comparative 1) | 27.54 | 11.07 | 0.40 | 0.42 ± 0.02 | 54.95 | 21.66 | 0.39 | 0.33 ± 0.07 |
| B (Comparative 2) | 40.01 | 16.93 | 0.42 | | 80.41 | 20.84 | 0.26 | |
| C (Comparative 3) | 37.86 | 16.09 | 0.43 | | 76.18 | 27.03 | 0.35 | |
| D (Example 1) | 46.70 | 7.47 | 0.16 | 0.19 ± 0.03 | 93.05 | 12.65 | 0.14 | 0.15 ± 0.01 |
| E (Example 2) | 38.29 | 7.09 | 0.19 | | 76.74 | 11.90 | 0.16 | |
| F (Example 3) | 27.02 | 5.77 | 0.21 | | 54.89 | 8.93 | 0.16 | |

### Method of Measuring Foam Hardness

The hardness of the foam (e.g. polyurethane foam) was measured using a LX-F type foam/sponge hardness tester. Such hardness testers are commercially available, for example, testers are available under the brand name CNYST or GRAIGAR. The LX-F type foam hardness tester is suitable for the determination of hardness of soft foam, polyurethane foam, rubber products etc. When using, the presser foot of the tester is directly in contact with the sample, and tester's own weight as the force measurement load. The LX-F foam hardness tester has the following specifications:

The scale value (Dial): 0 to 100 degrees

Scope of pressure needle route: 0 to 2.5 millimeters

Force of pressure needle end: 550 mN to 4300 mN

While using the tester, the middle of the tester is handheld and slowly put on to the top surface of the foam sample. When hardness tester presser foot smoothly contacts the sample, the number on the dial is read within one second. That is the hardness of the sample. For higher accuracy, the sample should be set on flat glass sheet or surface. Every test point should only read one result, and more than 5 test points should be taken for each sample with 25 mm interval. Average of the test results across multiple test points is used as hardness of the material.

While measuring hardness of the foam, the thickness of the tested sample should be 25 mm to 30 mm. When thickness of the sample material is no more than 25 mm, two overlay pieces could be used, but the contact surface should be flat, and the overlays together must meet the thickness requirement. The width and length of the sample should be more than 100 mm Test points should be located at the area more than 400 mm from the edge of the sample. The interval between test points should be more than 25 mm. To prepare the sample, the residual coat of the sample should be removed and the sample be made of uniform thickness without any mechanical fault. The sample adjustment and test environment is specified under GB/T2941-91.

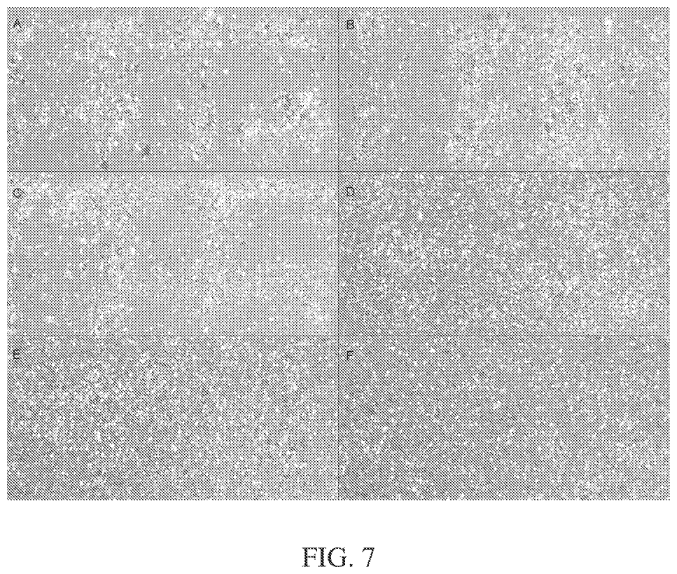

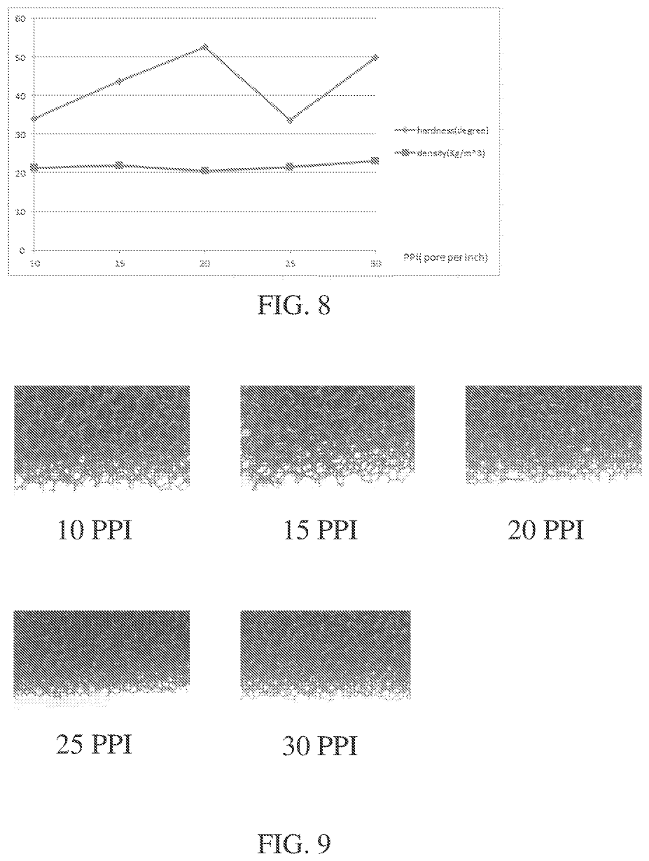

Various samples of reticulated polyurethane foam were measured using the above described LX-F type foam hardness tester. In particular, the hardnesses of reticulated polyurethane foams having 10 PPI (pores per inch), 15 PPI, 20 PPI, 25 PPI, and 30 PPI specifications were measured. The hardness test results are shown in FIG. 8. Sample images of various types of foams are shown in FIG. 9. As it is seen from FIG. 8, the cell size appears to influence the hardness. Generally, in large cell size foams, the filaments are coarse. Conversely, in small cell size foams the filaments are thinner.

The compositions, methods, and articles can alternatively comprise, consist of, or consist essentially of, any appropriate components or steps herein disclosed. The compositions, methods, and articles can additionally, or alternatively, be formulated so as to be devoid, or substantially free, of any steps, components, materials, ingredients, or species that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first”, “second”, and the like, do not denote any order, quantity, or importance, but rather are used to denote one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise.

Unless defined otherwise, technical and scientific terms used herein have the same meaning as is commonly understood by one of skill in the art to which this invention belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A paint roller cover comprising:
a foam having
a surface extending between a first edge and a second edge and
a groove on the surface wherein the groove is characterized in that a portion of the groove is positioned at an angle relative to an edge of the foam and by a groove depth off to 15 millimeters,
an average cell size in the range of about 0.03 to about 0.5 cm.

2. The paint roller cover of claim 1, wherein the paint roller c as an outer diameter of 50 to 90 millimeters.

3. The paint roller cover of claim 1, wherein the groove is in a regular pattern.

4. The paint roller cover of claim 1 wherein the groove is in an irregular pattern.

5. The paint roller cover of any of the preceding claims wherein the groove is a helix pattern or a diamond pattern.

6. The paint roller cover of claim 5, wherein the groove is a helix pattern with a pitch of 5 to 40 millimeters.

7. The paint roller cover of any of claim 1 wherein the foam is characterized by cells on the surface which are open to the surface.

8. The paint roller cover of claim 1, wherein the foam is a reticulated polymer foam.

9. The paint roller cover of claim 1 wherein the foam has a thickness of 5 to 25 millimeters.

10. The paint roller cover of claim 1 wherein the foam is polyurethane.

11. The paint roller cover of claim 1 wherein the foam is characterized by a cell frequency of 2 to 30 pores per centimeter.

12. The paint roller cover of claim 1 wherein the foam is characterized by a hardness of a hardness of 20 to 60 degrees as measured by LX-F type foam hardness tester.

13. A method of uniformly applying multicolor paint which comprises two or more paints of different colors in discrete domains from each wherein the domains have an average domain size, comprising:
applying the multicolor paint to the paint roller cover of claim 1, wherein the average cell size of the foam is within 25% of the average domain size in the multicolor paint;
rolling the paint roller cover on a surface to form a painted surface.

14. The method of claim 13 wherein in a histogram of a digitized image of the painted surface, spot counts measured in an x direction and a y direction show a variance in average intensity in the x direction or the y direction of less than 0.25 and/or the sum of variances in the x direction and the v direction is less than 0.45.

15. A method of characterizing uniformity of a paint applied to a surface, comprising:
digitizing an image of a painted surface;
measuring spot counts in a y direction and an x direction of the digitized image;
calculating the variance of spot counts in the x and y direction;
determining if the variance of spots counts is greater or less than a target value.

16. The paint roller cover of claim 1 wherein the groove has a depth of 1 to 2 millimeters.
